(19) United States
(12) Patent Application Publication
(10) Pub. No.: US 2024/0243449 A1
(43) Pub. Date: Jul. 18, 2024

(54) BATTERY CELL STRUCTURE

(71) Applicant: AMITA TECHNOLOGIES INC., Taoyuan City (TW)

(72) Inventor: Yuan-Li CHIANG, Taoyuan City (TW)

(21) Appl. No.: 18/133,978

(22) Filed: Apr. 12, 2023

(30) Foreign Application Priority Data
Jan. 12, 2023 (TW) 112101384

(51) Int. Cl. H01M 50/583; H01M 50/533; H01M 50/534

(52) U.S. Cl. CPC H01M 50/583; H01M 50/533; H01M 50/534

(57) ABSTRACT

The battery cell structure includes a body and an electrode tab. The electrode tab is disposed on a side of the body and outward extended from the body. Two sides of the electrode tab are separately disposed with a slit. Each slit has two inner edges adjacent to each other. The two slits are staggered along a longitudinal direction of the electrode tab and overlapped with each other along a transverse direction of the electrode tab. When an overcurrent occurs at the electrode tab, the electrode tab may melt between the slits to prevent the battery cell structure from overheating and firing.

### BACKGROUND

### Technical Field

The disclosure relates to a lithium battery, particularly to a battery cell structure with an overcurrent melting function.

### Related Art

With the progressive development of the lithium battery technology, lithium batteries are widely applied to many fields of daily life. Lithium batteries have been applied to electric vehicles. Because an electric vehicle requires a large electric current, it is easy to cause overcurrent and firing. Once a lithium battery catches fire, it is difficult to be extinguished. To prevent a lithium battery from overcurrent and firing, electric circuits in an electric vehicle are equipped with a fuse mechanism. An overcurrent fuse utilizes the impedance of a fuse itself for heat generation. Namely, a current flow through a fuse to generate heat which heats up the fuse, the fuse may be melted to form an open loop when the fuse is heated up to a predetermined melting temperature. A fuse has a higher impedance, so the temperature rises to be disadvantageous to large current charge and discharge when a larger current passes. The overheated electrode tab may accelerate aging of a battery cell. Also, there is a risk of firing.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

This disclosure provides a battery cell structure with an overcurrent fusing function.

The disclosure provides a battery cell structure, which includes a body and an electrode tab. The electrode tab is disposed on a side of the body and outward extended from the body. Two sides of the electrode tab are separately disposed with a slit. Each slit has two inner edges adjacent to each other. The two slits are staggered along a longitudinal direction of the electrode tab and overlapped with each other along a transverse direction of the electrode tab.

In an embodiment of the disclosure, the battery cell structure further includes another electrode tab. The electrode tab is a positive electrode tab, and another electrode tab is a negative electrode tab. The electrode tab is made of aluminum, and another electrode tab is made of copper.

In an embodiment of the disclosure, the body includes an outer bag and multiple electrode sheets, the electrode sheets are stacked and received in the outer bag, and the electrode tab is connected to a portion of the multiple electrode sheets and projects from the outer bag.

In an embodiment of the disclosure, the two inner edges of each slit are in contact with each other.

In an embodiment of the disclosure, an overlapping distance of the two slits along the transverse direction of the electrode tab is greater than one third of a width of the electrode tab.

In an embodiment of the disclosure, the electrode tab is greater than 0.3 mm in thickness.

In the battery cell structure of the disclosure, two sides of at least one electrode tab are correspondingly disposed with two slits, and the two slits are staggered along the longitudinal direction of the electrode tab to form a current passage between the two slits. A width of the current passage is less than a width of the electrode tab. When an overcurrent occurs at the electrode tab, the temperature of the current passage suddenly rises to melt to prevent the battery cell structure from overheating and firing.

### BRIEF DESCRIPTION OF THE DRAWINGS

FIG. 1 is a perspective schematic view of an embodiment of the battery cell structure of the disclosure:

FIG. 2 is a schematic view of the electrode tab of an embodiment of the battery cell structure of the disclosure: and

FIG. 3 is a front view of an embodiment of the battery cell structure of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

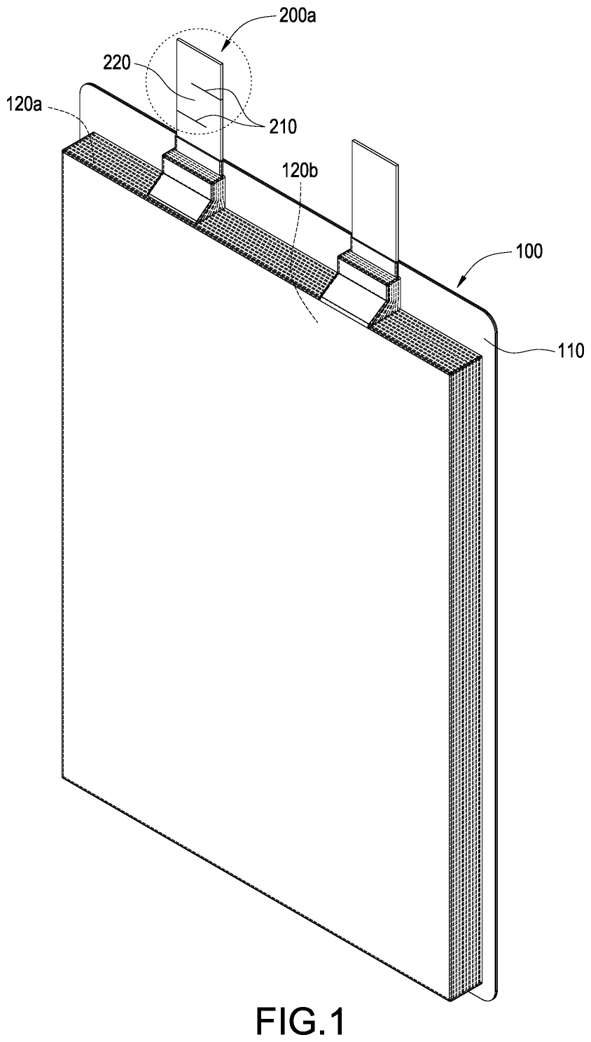

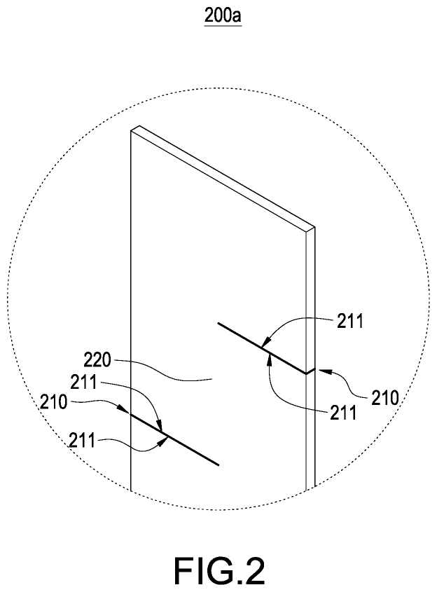

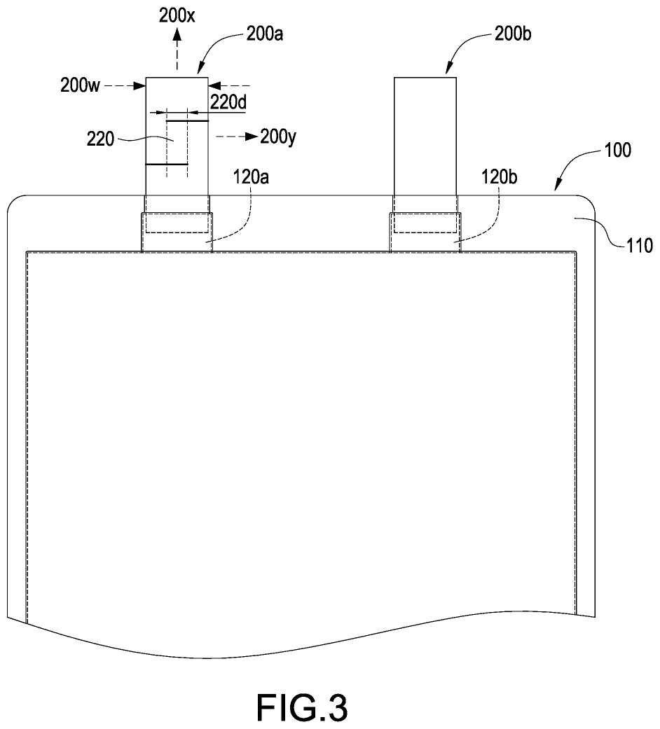

Please refer to FIGS. 1-3. The disclosure provides a battery cell structure, which includes a body 100 and at least one electrode tab.

The body 100 includes an outer bag 100 and multiple electrode sheets. The electrode sheets are stacked and received in the outer bag 100. The electrode sheets include at least one positive electrode sheet 120a and at least one negative electrode sheet 120b. The positive electrode sheet 120a and the negative electrode sheet 120b are alternately stacked. The positive electrode sheet 120a and the negative electrode sheet 120b are separately made of different materials to establish a potential difference therebetween. In the embodiment, the multiple electrode sheets include multiple positive electrode sheets 120a made of aluminum and multiple negative electrode sheets 120b made of copper.

The electrode tab is connected to a portion of the multiple electrode sheets and projects from the outer bag 100. In the embodiment, the battery cell structure of the disclosure includes a pair of electrode tabs, one of them is a positive electrode tab 200a, and the other one is a negative electrode tab 200b. The positive electrode tab 200a is made of aluminum and connected to the positive electrode sheets 120a. The negative electrode tab 200b is made of copper and connected to the negative electrode sheets 120b. Each electrode tab is disposed on a side of the body 100 and outward extended from the body 100. The two electrode tabs may be disposed on the same side or opposite sides of the body 100, but not limited to this.

Two sides of the electrode tab are respectively disposed with a slit 210. The slits 210 may be disposed on any one of the electrode tabs. In the embodiment, the slits 210 are disposed on the positive electrode tab 200a made of aluminum, but not limited to this. In the embodiment, each electrode tab is greater than 0.3 mm in thickness, the disclosure is not limited to this, but at least the electrode tab with the slit 210 is greater than 0.3 mm in thickness. In detail, the extending length direction of the electrode tab is a longitudinal direction of the electrode tab, and a transverse direction is defined to be parallel to a direction of the width 200w of the electrode tab. The two slits 210 are staggered along the longitudinal direction of the electrode tab and overlapped with each other along the transverse direction of the electrode tab (viewed from the longitudinal direction). The overlapping distance 220d of the two slits 210 along the transverse direction of the positive electrode tab 200a is greater than one third of the width 200w of the positive electrode tab 200a. In the embodiment, each slit 210 extends toward a direction parallel to the transverse direction of the electrode tab, but not limited to this, an extension direction of each slit 210 may also be unparallel to the transverse direction of the electrode tab. Each slit 210 has two inner edges 211 adjacent to each other. The two inner edges 211 of each slit 210 may be in contact with each other or arranged at a small interval. Therefore, the heat delivered in the electrode tab may still pass through each slit 210 along the longitudinal direction of the electrode tab to prevent the thermal diffusion of the electrode tab from being affected.

In the battery cell structure of the disclosure, two sides of at least one electrode tab are correspondingly disposed with two slits 210, and the two slits 210 are staggered along the longitudinal direction of the electrode tab, where they are located, to form a current passage 220 between the two slits 210. A width of the current passage 220 is less than a width 200w of the electrode tab. When an overcurrent occurs at the electrode tab, the temperature of the current passage 220 suddenly rises to melt to prevent the battery cell structure from overheating and firing. The overlapping distance 220d of the two slits 210 along the transverse direction of the electrode tab is the minimum required length of the current passage 220. A length of the current passage 220 needs to be greater than one third of the width 200w of the positive electrode tab 200a to guarantee the current passage 220 to be fusible. In some embodiments, the at least two slits 210, which are staggered and separately arranged on opposite sides of the electrode tab, may accomplish the object of the disclosure. The number of the slits 210 may be increased depending upon the requirements. Part of the current passage 220 is formed between every adjacent two of the slits 210 to extend the length of the current passage 220.

In the embodiment, the slits 210 are disposed on the positive electrode tab 200a. The positive electrode tab 200a is made of aluminum with melting point lower than the negative electrode tab 200b made of copper, to prevent another electrode tab from overloading and firing before the current passage 220 melts.

In the embodiment, the slits 210 are disposed on the electrode tab with a thickness greater than 0.3 mm. As a result, a narrow current passage 220 may be formed on a portion of the thicker electrode tab to guarantee the electrode tab melts before the whole battery cell structure starts firing.

In the battery cell structure of the disclosure, the inner edges 211 of the slit 210 of the electrode tab are adjacently arranged, so large heat may not be generated when a large current passes the electrode tab 210 under a normal working status, and the heat generated by the current passing the electrode tab 210 may also be dissipated in time. Once a short circuit current occurs (usually a short circuit current is more than 20 times the maximum allowable charge and discharge current), both the impact of the huge current and instantly generated heat make the electrode tab quickly withstand the heat that cannot be dissipated. Part of the conductive cross-sectional area of the electrode tab is reduced by cutting the slit 210, so that the reduced place is not able to withstand the impact of a huge current, and the place is broken. As a result, the structure may accomplish the function of short circuit protection. Also, the structure may avoid temperature rising of the electrode tab caused by charge and discharge of a large current, so that battery aging cause by temperature rising of the electrode tab may be avoided.

While this disclosure has been described by means of specific embodiments, numerous modifications and variations could be made thereto by those skilled in the art without departing from the scope and spirit of this disclosure set forth in the claims.

What is claimed is:

1. A battery cell structure comprising:
a body; and
an electrode tab, disposed on a side of the body, and outward extended from the body;
wherein a slit is respectively disposed on two sides of the electrode tab, the slit comprises two inner edges adjacent to each other, and two slits are staggered with each other along a longitudinal direction of the electrode tab and overlapped with each other along a transverse direction of the electrode tab.

2. The battery cell structure of claim 1, further comprising another electrode tab.

3. The battery cell structure of claim 2, wherein the electrode tab is a positive electrode tab, and another electrode tab is a negative electrode tab.

4. The battery cell structure of claim 2, wherein the electrode tab is made of an aluminum material, and another electrode tab is made of a copper material.

5. The battery cell structure of claim 1, wherein the electrode tab is made of an aluminum material.

6. The battery cell structure of claim 1, wherein the body comprises an outer bag and multiple electrode sheets, the electrode sheets are stacked and received in the outer bag, and the electrode tab is connected to a portion of the electrode sheets and projects from the outer bag.

7. The battery cell structure of claim 1, wherein the two inner edges of each slit are in contact with each other.

8. The battery cell structure of claim 1, wherein an overlapping distance of the two slits along the transverse direction of the electrode tab is greater than one third of a width of the electrode tab.

9. The battery cell structure of claim 1, wherein the electrode tab is greater than 0.3 mm in thickness.
